(19) United States
(12) Patent Application Publication
(10) Pub. No.: US 2017/0118017 A1
(43) Pub. Date: Apr. 27, 2017

(54) SYSTEMS AND METHODS FOR CRYPTOGRAPHY USING FOLDING UNIT COMPUTATIONS

(71) Applicant: Numecent Holdings, Inc., Irvine, CA (US)

(72) Inventor: Mehdi Sotoodeh, Mission Viejo, CA (US)

(73) Assignee: Numecent Holdings, Inc., Irvine, CA (US)

(21) Appl. No.: 15/175,586

(22) Filed: Jun. 7, 2016

Related U.S. Application Data
(60) Provisional application No. 62/182,376, filed on Jun. 19, 2015.
(60) Provisional application No. 62/186,165, filed on Jun. 29, 2015.

(51) Int. Cl. H04L 9/08; G06F 7/58; H04L 9/32; G06F 7/523; H04L 9/14; H04L 9/30

(52) U.S. Cl. CPC H04L 9/0869; H04L 9/14; H04L 9/3066; H04L 9/3247; G06F 7/523; G06F 7/582

(57) ABSTRACT

The systems and methods described herein provide computationally effective ways to calculate cryptography key pairs for a variety of cryptography applications, including but not limited to encryption/decryption systems, digital signature systems, encrypting file systems, etc. In various implementations, a cryptography key computation system identifies an encryption function, such as an elliptical curve function, that is used as the basis of a cryptography key pair. The cryptography key computation system may further identify a basepoint on the encryption function as well as a scalar that is to be multiplied by the basepoint. The cryptography key computation system may decompose the scalar into a sum of “folding units,” e.g., smaller scalars that are represented by the product of a coefficient and a power of an integer. In some implementations, the coefficients of the folding units may be precomputed. Permutations of specific coefficients may be cached/stored using the techniques described herein.

### CLAIM OF PRIORITY

This application claims priority to U.S. Provisional Patent Application Nos. 62/182,376 filed on Jun. 19, 2015, and 62/186,165, filed on Jun. 29, 2015, the contents of which are incorporated by reference herein.

### TECHNICAL FIELD

The technical field relates to computer security systems and methods. More specifically, the technical field relates to computer cryptography systems and methods.

### BACKGROUND

Public cryptography key cryptography systems use pairs of keys, such as a public cryptography key and a private cryptography key, to secure data. In these systems, the public cryptography key is mathematically related to the private cryptography key by a mathematical algorithm that forms the basis of encryption. The private cryptography key may be kept private by a specific entity, while the public cryptography key may be distributed to others wishing to send secure data to or receive secure data from the specific entity. Due to the complexity of the mathematical algorithm that forms the basis of encryption, data encrypted with the public cryptography key may only be decrypted with the private cryptography key and conversely, data encrypted with the private cryptography key may only be decrypted with the public cryptography key. Known public cryptography key cryptography systems include Rivest-Shamir-Adleman (“RSA”) cryptography systems and Elliptic Curve Cryptography (“ECC”) cryptography systems.

In many public cryptography key cryptography systems, the mathematical algorithm that forms the basis of encryption involves complex operations that are difficult to process, particularly on digital devices with constrained resources. Systems and methods that efficiently perform the operations underlying the mathematical algorithms of public cryptography key cryptography systems would be helpful. Other aspects of any relevant art will become apparent to those of skill in the art upon review of the specification, the drawings, and the claims herein.

### SUMMARY

The systems and methods described herein provide computationally effective ways to calculate cryptography key pairs for a variety of cryptography applications, including but not limited to encryption/decryption systems, digital signature systems, encrypting file systems, etc. In various implementations, a cryptography key computation system identifies an encryption function, such as an elliptical curve function, that is used as the basis of a cryptography key pair. The cryptography key computation system may further identify a basepoint on the encryption function as well as a scalar that is to be multiplied by the basepoint. The cryptography key computation system may decompose the scalar into a sum of “folding units,” e.g., smaller scalars that are represented by the product of a coefficient and a power of an integer. In some implementations, the coefficients of the folding units may be precomputed. Permutations of specific coefficients may be cached/stored using the techniques described herein.

Each folding unit may be multiplied against the basepoint, and these products may be added to produce the point multiple of the scalar and the basepoint of the encryption function. In various implementations, the cryptography key computation system uses the scalar and as a private cryptography key, and the point multiple of the scalar and the basepoint of the encryption function as the corresponding public cryptography key. As a result, the systems and methods described herein allow the generation of cryptography key pairs without having to use “double and add” techniques or other computationally intense techniques that are commonly used to perform point multiplication of a scalar and a basepoint on an encryption function.

A system may include a cryptography system interface engine configured to receive from one or more cryptography systems a notification of a cryptography operation. A scalar identification engine coupled to the cryptography system interface engine may be configured to identify a scalar to be used for a cryptography key pair for the cryptography operation. An encryption function management engine coupled to the cryptography system interface engine may be configured to identify a basepoint of an encryption function to be used for the cryptography key pair. A scalar fold operation management engine coupled to the scalar identification engine may be configured to decompose the scalar into folding units, each of the folding units used for point multiplication against the basepoint. A folding unit multiplication engine coupled to the scalar fold operation management engine may be configured to perform point multiplication of each of the folding units against the basepoint. A point multiplication recomposition engine coupled to the folding unit multiplication engine may be configured to recompose a point multiple of the scalar and the basepoint using a sum of individual products of the folding units and the basepoint. A cryptography key management engine coupled to the point multiplication recomposition engine may be configured to create the cryptography key pair using the scalar and the point multiple of the scalar and the basepoint.

The cryptography system interface engine may be configured to provide one or more of the cryptography key pair to the one or more cryptography systems. Each of the folding units may comprise a product of a coefficient and specified power of an integer. The integer may be the number 2.

The scalar fold operation management engine may be configured to: represent a magnitude of the scalar as a product of a coefficient and a specified power of an integer; identify one or more permutations of the coefficients; store in a folding unit datastore the one or more permutations of the coefficients.

The encryption function may be an elliptical curve function. The encryption function may be an elliptical curve function defined over a finite field.

The cryptography key pair may comprise a private cryptography key based on the scalar, and a public cryptography key based on the point multiple of the scalar and the basepoint.

In some implementations, the scalar is generated using one or more of a random number generator and a pseudorandom number generator.

At least a portion of the cryptography operation may be performed by one or more of an encryption/decryption system, a digital signature system, and an Encrypting File System (“EFS”). At least a portion of the cryptography operation may be performed by one or more of a server, a desktop computer, a laptop computer, a tablet computing device, a mobile phone, and an Internet of Things (“IoT”) device.

A method may comprise: receiving from one or more cryptography systems a notification of a cryptography operation; identifying a scalar to be used for a cryptography key pair for the cryptography operation; identifying a basepoint of an encryption function to be used for the cryptography key pair; decomposing the scalar into folding units, each of the folding units used for point multiplication against the basepoint; performing point multiplication of each of the folding units against the basepoint; recomposing a point multiple of the scalar and the basepoint using a sum of individual products f the folding units and the basepoint; creating the cryptography key pair using the scalar and the point multiple of the scalar and the basepoint; providing one or more of the cryptography key pair to the one or more cryptography systems.

Each of the folding units may comprise a product of a coefficient and specified power of an integer. The integer may be the number 2.

Decomposing the scalar into the folding units may comprise: representing a magnitude of the scalar as a product of a coefficient and a specified power of an integer; identifying one or more permutations of the coefficients; storing in a folding unit datastore the one or more permutations of the coefficients.

The encryption function may be an elliptical curve function. The encryption function may be an elliptical curve function defined over a finite field.

The cryptography key pair may comprise a private cryptography key based on the scalar, and a public cryptography key based on the point multiple of the scalar and the basepoint.

In some implementations, the scalar is generated using one or more of a random number generator and a pseudorandom number generator.

At least a portion of the cryptography operation may be performed by one or more of an encryption/decryption system, a digital signature system, and an Encrypting File System (“EFS”). At least a portion of the cryptography operation may be performed by one or more of a server, a desktop computer, a laptop computer, a tablet computing device, a mobile phone, and an Internet of Things (“IoT”) device.

A system may comprise: means for receiving from one or more cryptography systems a notification of a cryptography operation; means for identifying a scalar to be used for a cryptography key pair for the cryptography operation; means for identifying a basepoint of an encryption function to be used for the cryptography key pair; means for decomposing the scalar into folding units, each of the folding units used for point multiplication against the basepoint; means for performing point multiplication of each of the folding units against the basepoint; means for recomposing a point multiple of the scalar and the basepoint using a sum of individual products of the folding units and the basepoint; means for creating the cryptography key pair using the scalar and the point multiple of the scalar and the basepoint; means for providing one or more of the cryptography key pair to the one or more cryptography systems.

Other features and implementations are apparent from the related drawings and from the detailed description.

### BRIEF DESCRIPTION OF THE DRAWINGS

FIG. 1 is a diagram showing an example of a cryptography environment.

FIG. 2 is a flowchart of an example of method for providing keys used in a cryptography system.

FIG. 3 is a diagram showing an example of a cryptography key computation system.

FIG. 4 is a flowchart of an example of method for creating keys by decomposing a scalar into folding units used in a cryptographic system.

FIG. 5A is a diagram showing an example of a scalar fold operation management engine.

FIG. 5B is a diagram showing an example of a scalar being decomposed into a sum of folding units, the coefficients of which are cached.

FIG. 6 is a flowchart of an example of method for decomposing a scalar into folding units used in a cryptographic system.

FIG. 7 is a diagram showing an example of an encryption function management engine.

FIG. 8 is a flowchart of an example of method for selecting an encryption function for a cryptography system.

FIG. 9 is a diagram showing an example of a cryptography key management engine.

FIG. 10 is a flowchart of an example of method for creating a pair of keys used in a cryptographic system.

FIG. 11 is a diagram showing an example of a computer system.

### DETAILED DESCRIPTION

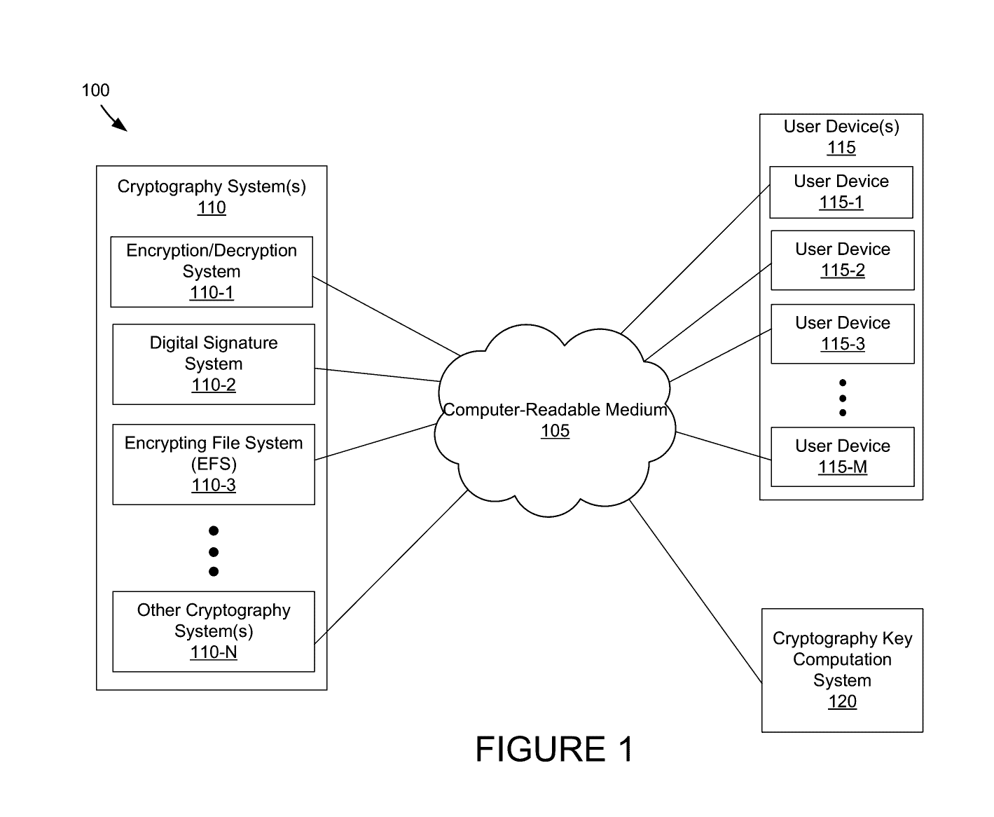

FIG. 1 is a diagram showing an example of a cryptography environment 100. In the example of FIG. 1, the cryptography environment 100 includes a computer-readable medium 105, cryptography systems 110-1 through 110-N (collectively “cryptography system(s) 110”), user devices 115-1 through 115-M (collectively “user device(s) 115”), and a cryptography key computation system 120. The computer-readable medium 105 may be coupled to the cryptography system(s) 110, the user device(s), and the cryptography key computation system 120.

The computer-readable medium 105, the cryptography system(s) 110, the user device(s) 115, and the cryptography key computation system 120 can be implemented as a computer system or parts of a computer system or a plurality of computer systems. A computer system, as used in this paper, can include or be implemented as a specific purpose computer system for carrying out the functionalities described in this paper. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, IDSN modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine or through multiple engines. As used in this paper, an engine includes at least two components: 1) a dedicated or shared processor and 2) hardware, firmware, and/or software modules that are executed by the processor. Depending upon implementation-specific or other considerations, an engine can be centralized or its functionality distributed. An engine can be a specific purpose engine that includes specific purpose hardware, firmware, or software embodied in a computer-readable medium for execution by the processor. The processor transforms data into new data using implemented data structures and methods, such as is described with reference to the drawings referenced herein.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud based datastore is a datastore that is compatible with cloud-based computing systems and engines.

The computer-readable medium 105 may comprise a “computer-readable medium,” as discussed in this paper. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (non-volatile storage, volatile storage, etc.), but may or may not be limited to hardware. The computer-readable medium 105 is intended to represent a variety of potentially applicable technologies. For example, the computer-readable medium 105 can be used to form a network or part of a network. Where two components are co-located on a device, the computer-readable medium 105 can include a bus or other data conduit or plane.

Where a first component is co-located on one device and a second component is located on a different device, the computer-readable medium 105 can include a computer network. More specifically, the computer-readable medium 105 may include a networked system that includes several computer systems coupled together, such as the Internet. The term “Internet” as used herein refers to a network of networks that uses certain protocols, such as the TCP/IP protocol, and possibly other protocols such as the hypertext transfer protocol (HTTP) for hypertext markup language (HTML) documents that make up the World Wide Web (the web). Content is often provided by content servers, which are referred to as being “on” the Internet. A web server, which is one type of content server, is typically at least one computer system which operates as a server computer system and is configured to operate with the protocols of the web and is coupled to the Internet. The physical connections of the Internet and the protocols and communication procedures of the Internet and the web are well known to those of skill in the relevant art. In various implementations, the computer-readable medium 105 may be implemented as a computer-readable medium, such as a bus, that couples components of a single computer together. For illustrative purposes, it is assumed the computer-readable medium 105 broadly includes, as understood from relevant context, anything from a minimalist coupling of the components illustrated in the example of FIG. 1, to every component of the Internet and networks coupled to the Internet.

In various implementations, the computer-readable medium 105 may include technologies such as Ethernet, 802.11, worldwide interoperability for microwave access (WiMAX), 3G, 4G, CDMA, GSM, LTE, digital subscriber line (DSL), etc. The computer-readable medium 105 may further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the computer-readable medium 105 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In a specific implementation, the cryptography system(s) 110 provide cryptography-related services to the user device(s) 115 and/or other computer systems. In various implementations, the cryptography system(s) 110 include an encryption/decryption system 110-1, a digital signature system 110-2, an Encrypting File System (“EFS”) 110-3, and other cryptography system(s) 110-N. Each of the encryption/decryption system 110-1, the digital signature system 110-2, the Encrypting File System (“EFS”) 110-3, and the other cryptography system(s) 110-N may be coupled to the computer-readable medium 105.

The encryption/decryption system 110-1 may encode and/or decode messages or information in such a way that only authorized parties can read the messages. In some implementations, the encryption/decryption system 110-1 may transform plaintext to ciphertext based on the cryptography key pairs generated by the cryptography key computation system 120. The encryption/decryption system 110-1 may transform ciphertext to plaintext based on the cryptography key pairs generated by the cryptography key computation system 120. The encryption/decryption system 110-1 may be used in a variety of systems, including digital rights management systems, systems that protect data in transit, for example data being transferred via networks (e.g. the Internet, e-commerce), mobile telephones, wireless microphones, wireless intercom systems, Bluetooth devices, bank automatic teller machines, etc. The encryption/decryption system 110-1 may also protect data from being eavesdropped by unauthorized users. In various implementations, the encryption/decryption system 110-1 may be used to perform message verification. The encryption/decryption system 110-1 may also verify message authentication codes of messages. Sometimes an adversary can obtain unencrypted information without directly undoing the encryption. The encryption/decryption system 110-1 may apply encryption/decryption techniques to ciphertext when it is created (typically on the same device used to compose the message) to avoid tampering.

The digital signature system 110-2 may verify digital signatures of messages based on the cryptography key pairs generated by the cryptography key computation system 120. The digital signature system 110-2 may support one or more mathematical schemes for demonstrating the authenticity of a digital message or document. The digital signatures may give a recipient reason to believe that the message was created by a known sender, that the sender cannot deny having sent the message (authentication and non-repudiation), and that the message was not altered in transit (integrity). The digital signature system 110-2 may use the digital signatures for software distribution, financial transactions, and in other cases where it is important to detect forgery or tampering. The EFS 110-3 may provide file-system level encryption based on the cryptography key computation system 120. The EFS 110-3 may be compatible with the New Technology File System and/or other known or convenient file systems. The other cryptography system(s) 110-N may comprise any other cryptography systems that use the cryptography key pairs generated by the cryptography key computation system 120.

In a specific implementation, the user device(s) 115 include one or more servers, desktop computers, laptop computers, tablet computing devices, mobile phones, Internet of Things (“IoT”) devices, etc. In some implementations, at least some of the user device(s) 110 are devices that have constrained resources. For instance, at least some of the user device(s) 110 may include mobile devices having relatively small amounts of memory and/or processing capabilities compared to the memory and/or processing capabilities of a desktop computer. Moreover, the user device(s) 115 may include applications, processes, etc. that access the cryptography system(s) 110. More specifically, the user device(s) 115 may include applications, processes, etc. that use encryption/decryption processes, digital signatures, EFS processes, etc.

In a specific implementation, the cryptography key computation system 120 computes a cryptography key pair for the cryptography system(s) 110. More specifically, the cryptography key computation system 120 may compute a private cryptography key and a public cryptography key for various applications, processes, etc. managed by the cryptography system(s) 110. In computing the cryptography key pair, the cryptography key computation system 120 may identify a basepoint on an encryption function and a scalar to be multiplied with the basepoint. An “encryption function, “as used herein may refer to any function that is used for a cryptography key pair. An example of an encryption function is an elliptical curve defined over a finite field. A “basepoint” of an encryption function, as used herein, may refer to an arbitrary point on the encryption function that is used as the basis of a public cryptography key created using that encryption function. In implementations where the encryption function is an elliptical function, a basepoint may correspond to any specific point on the elliptical function. A “scalar,” as used herein, may refer to any scalar quantity. Examples of scalars include integer values, real number values, values taken from a finite group or field, etc.

The cryptography key computation system 120 may decompose the scalar into a sum of folding units. A “folding unit,” as used herein, may refer to a portion of the scalar that is represented by a product of a coefficient and a specified power of a specified integer. Though arbitrary, the specified integer may be chosen to maximize computational efficiency in some implementations. For instance, in some implementations, the specified integer is the number “2.” In these implementations, the folding units correspond to specific chunks of bits of the scalar. Moreover, though also arbitrary, the specified power may be chosen based on a variety of factors, including the extent the decomposition methods are designed to perform computations up-front. As an example, for a 256 bit scalar, the specified power may be chosen to be one of 4, 16, 64, etc., depending on the extent of front-end calculations desired. In various implementations, the cryptography key computation system 120 stores/caches in a table permutations of coefficients for each folding unit. Naturally, the storage/caching table sizes may vary depending on the size of the specified power. The cryptography key computation system 120 may use stored/cached permutations of the coefficients for each folding unit to recompose the point multiple of the scalar and the basepoint. More specifically, the cryptography key computation system 120 may perform a summation in which the products of the folding units and the scalar are added on a folding unit-by-folding unit basis.

As an example of decomposing a scalar into folding units, the following example, shown in Equation 1, is provided:

### Equation 1

Decomposition of an Arbitrary Point Multiple Q on an Encryption Function into Folding Units of the Power “s”, where Q is the Point Multiple of a Scalar a and a Basepoint P
Suppose P is an a basepoint of an encryption function such as an elliptical curve.
Suppose a is a scalar.
Then, the scalar a can be decomposed into integer multiples of a number s, such that sⁿ⁻¹ is less than the number a.
More specifically:

a=a₀+a₁*s+a₂*s²+ . . . +aₙ₋₁*sⁿ⁻¹.
Further suppose Q is a point on the encryption function that is the point multiple of a and P, such that Q=a*P.
Then, Q can be expressed as:

(a₀+a₁*s+a₂*s²+ . . . +aₙ₋₁*sⁿ⁻¹)*P
Further suppose Pᵢ=sⁱ*P, due to the properties of point multiplication of the scalar a and the basepoint P on the encryption function.
The points Pᵢ may be precomputed
The permutations of SUM (P₀, . . . Pₙ₋₁) may be stored/cached.
Due to the properties of point multiplication:

Q=(a₀*P₀+a₁*P₁+a₂*P₂+ . . . +aₙ₋₁Pₙ₋₁)
This point multiplication can be performed using the stored/cached permutations of SUM (P₀, . . . Pₙ₋₁) and the precomputed points Pᵢ.

As another example of decomposing a scalar into folding units, the following example of decomposing a 256-bit scalar, shown in Equation 2, is provided:

### Equation 2

Decomposition of an Arbitrary Point Multiple Q on an Encryption Function into Folding Units of the Power 2, where Q is the Point Multiple of a Scalar a and a Basepoint P
Suppose P is an a basepoint of an encryption function such as an elliptical curve.
Suppose a is a 256-bit scalar.
Then, the scalar a can be decomposed into integer multiples of a number 2, such that 2ⁿ⁻¹ is less than the number a.
More specifically:

a=a₀+a₁*2+a₂*2²+ . . . +aₙ₋₁*2ⁿ⁻¹.
Further suppose Q is a point on the encryption function that is the point multiple of a and P, such that Q=a*P.
Then, Q can be expressed as:

(a₀+a₁*2+a₂*2²+ . . . +aₙ₋₁*2ⁿ⁻¹)*P
Further suppose Pᵢ=sⁱ*P, due to the properties of point multiplication of the scalar a and the basepoint P on the encryption function.
The points Pᵢ may be precomputed
The permutations of SUM (P₀, . . . Pₙ₋₁) may be stored/cached.
Due to the properties of point multiplication:

Q=(a₀*P₀+a₁*P₁+a₂*P₂+ . . . +aₙ₋₁Pₙ₋₁)
This point multiplication can be performed using the stored/cached permutations of SUM (P₀, . . . Pₙ₋₁) and the precomputed points Pᵢ.
In this case, n may be chosen to be 64 (e.g., the folding units may each be broken into units of 2⁶⁴) to reduce front-end computations but create larger storage/caching tables.
However, n may alternatively be chosen to be 4 (e.g., the folding units may each be broken into units of 2⁴) to reduce sizes of storage/caching tables but use larger front-end computations.

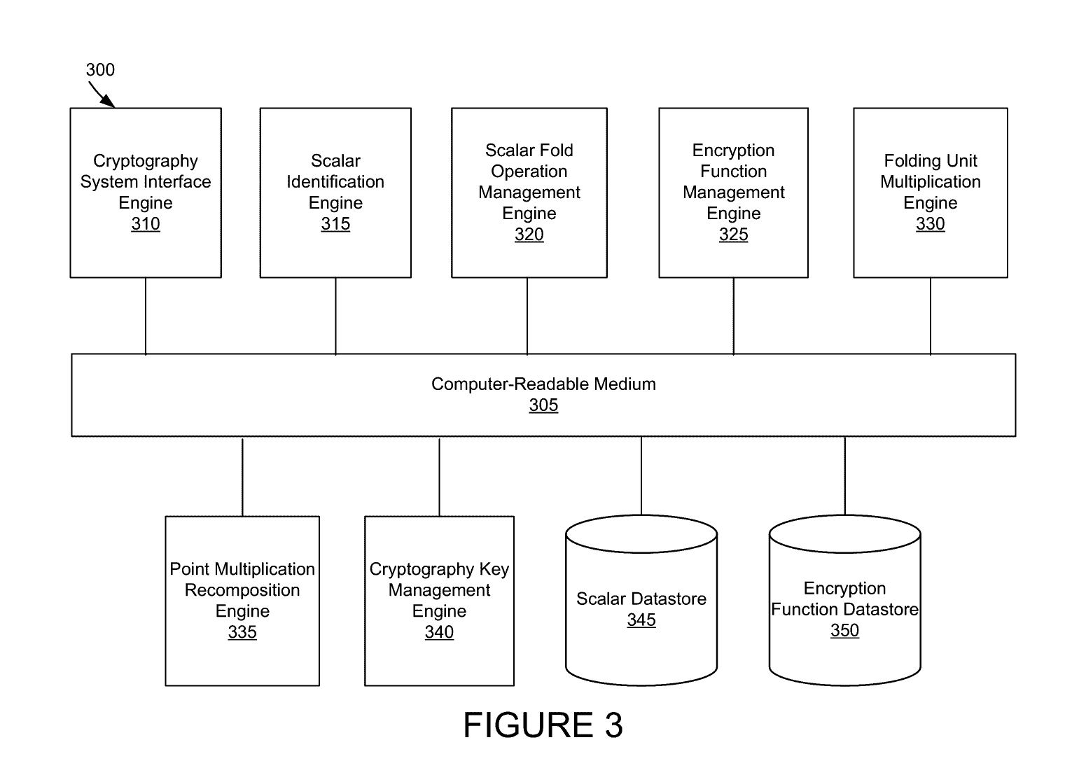

In various implementations, the scalar forms the basis of a private cryptography key, and the point multiple of the scalar and the basepoint forms the basis of a corresponding public cryptography key. The cryptography key computation system 120 may distribute the public cryptography key to various applications (e.g., any of the cryptography system(s) 110) and may securely store the private cryptography key. FIG. 3 shows an example of an implementation of the cryptography key computation system 120 in greater detail.

Though FIG. 1 shows the cryptography key computation system 120 as distinct from the cryptography system(s) 110 and/or the user device(s) 115, it is noted that in various implementations, the cryptography key computation system 120 may reside within one or more of the cryptography system(s) 110 and/or the user device(s) 115. Further, though FIG. 1 shows the cryptography key computation system 120 as a device, it is noted the cryptography key computation system 120 may be incorporated into libraries, classes, objects, etc. that can be incorporated into applications, processes, etc. managed by the cryptography system(s) 110 and/or the user device(s) 115.

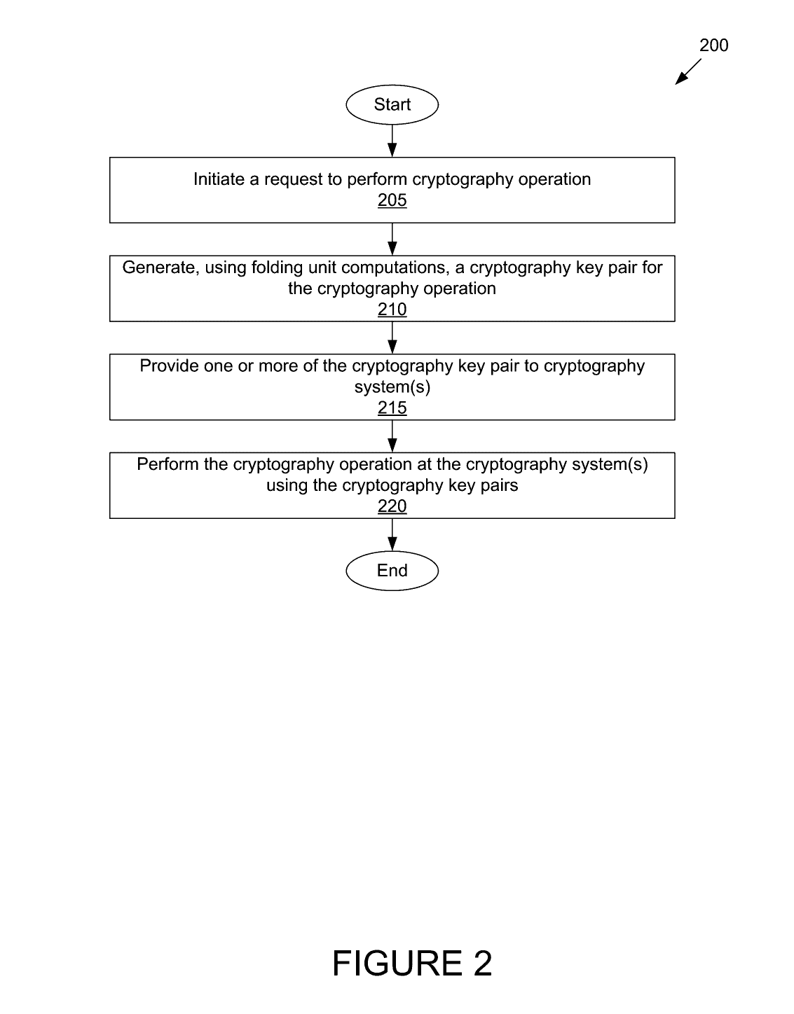

FIG. 2 is a flowchart 200 of an example of method for providing keys used in a cryptography system. The flowchart 200 is discussed in conjunction with the cryptography environment 100, shown in FIG. 1 and discussed further herein.

At module 205, the user device(s) 115 initiate a request to perform a cryptography operation. More specifically, the user device(s) 115 may request an encryption/decryption operation, a digital signature operation, an EFS operation, etc. These requests may be provided to the computer-readable medium 105 in various implementations.

At module 210, the cryptography key computation system 120 generates, using folding unit computations, a cryptography key pair for the cryptography operation. More specifically, the cryptography key computation system 120 may identify a scalar and an encryption function using the techniques described herein. The cryptography key computation system 120 may further perform point multiplication of the scalar and a basepoint on the encryption function using folding unit computations. To do so, the cryptography key computation system 120 may decompose the scalar into folding units of convenient size. The cryptography key computation system 120 may further store/cache relevant coefficients of folding units, and may multiply the folding units with relevant portions of the basepoint. The cryptography key computation system 120 may further add the specific products of folding units and the relevant portions of the basepoint as needed to recompose the point multiple of the scalar and the basepoint. The scalar may form the basis of a private key. The point multiple may form the basis of a corresponding public key.

At module 215, the cryptography key computation system 120 provides one or more of the cryptography key pair to the cryptography system(s) 110. In an implementation, only the public key may be provided to the cryptography key system(s) 110 while the private key may be kept private (e.g., secure from discovery). At module 220, the cryptography key pair to cryptography system(s) 110 perform the cryptography operation at the cryptography system(s) using the cryptography key pairs.

FIG. 3 is a diagram showing an example of a cryptography key computation system 300. The cryptography key computation system 300 includes a computer-readable medium 305, a cryptography system interface engine 310, a scalar identification engine 315, a scalar fold operation management engine 320, an encryption function management engine 325, a folding unit multiplication engine 330, a point multiplication recomposition engine 335, a cryptography key management engine 340, a scalar datastore 345, and an encryption function datastore 350. One or more of the cryptography system interface engine 310, the scalar identification engine 315, the scalar fold operation management engine 320, the encryption function management engine 325, the folding unit multiplication engine 330, the point multiplication recomposition engine 335, and the cryptography key management engine 340 may include an “engine,” as described further herein. One or more of the scalar datastore 345 and the encryption function datastore 350 may include a “datastore,” as described further herein.

In the example of FIG. 3, the computer-readable medium 305 is coupled to the cryptography system interface engine 310, the scalar identification engine 315, the scalar fold operation management engine 320, the encryption function management engine 325, the folding unit multiplication engine 330, the point multiplication recomposition engine 335, the cryptography key management engine 340, the scalar datastore 345, and the encryption function datastore 350. In various implementations, the computer-readable medium 305 may include a “computer-readable medium,” as described further herein.

In a specific implementation, the cryptography system interface engine 310 functions to interface with the cryptography system(s) 110. More specifically, the cryptography system interface engine 310 may receive from the cryptography system(s) 110 instructions to create specific cryptography key pairs. The specific cryptography key pairs may or may not be related to a specific cryptographic context, such as, an encryption/decryption context, a digital signature context, an EFS context, etc. The cryptography system interface engine 310 may further instruct the other engines and/or datastores of the cryptography key computation system 300 to identify values (scalars, basepoints of encryption functions, point multiples, etc.) that are used to create cryptography key pairs. In various implementations, the cryptography system interface engine 310 receives cryptography key pairs from the other engines of the cryptography key computation system 300, such as the cryptography key management engine 340.

In a specific implementation, the scalar identification engine 315 identifies specific scalars used for cryptography key pairs. In various implementations, the scalar identification engine 315 gathers potential values of scalars from the scalar datastore 345. The scalar may include any scalar quantity (e.g., integer values, real number values, values taken from a finite group or field, etc.).

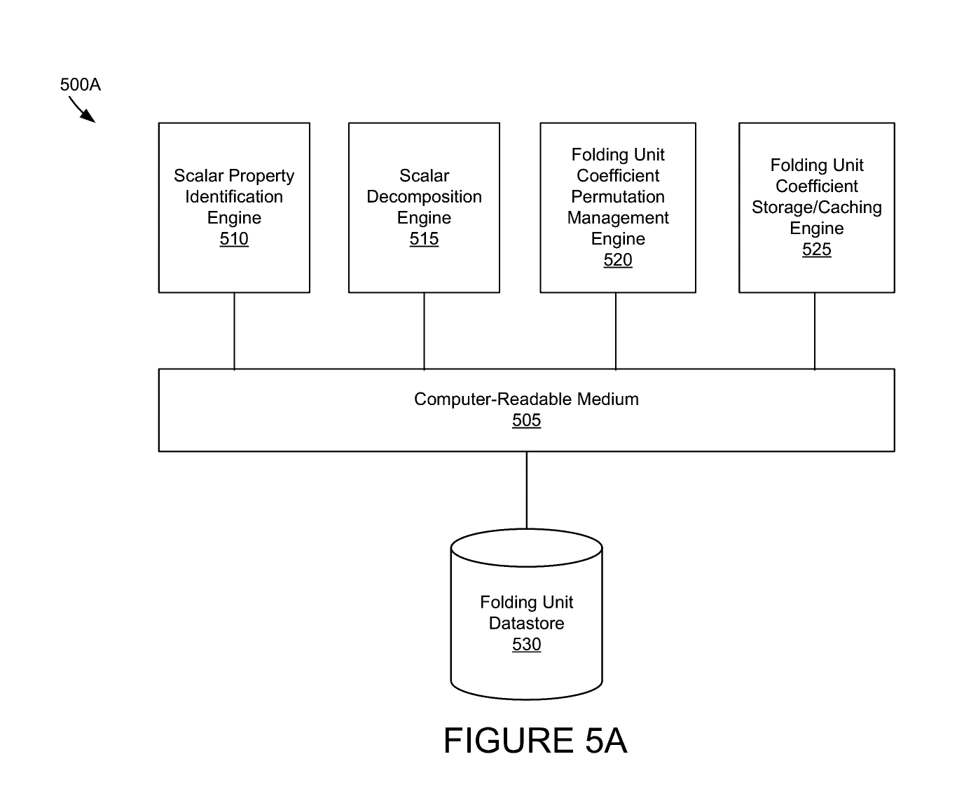

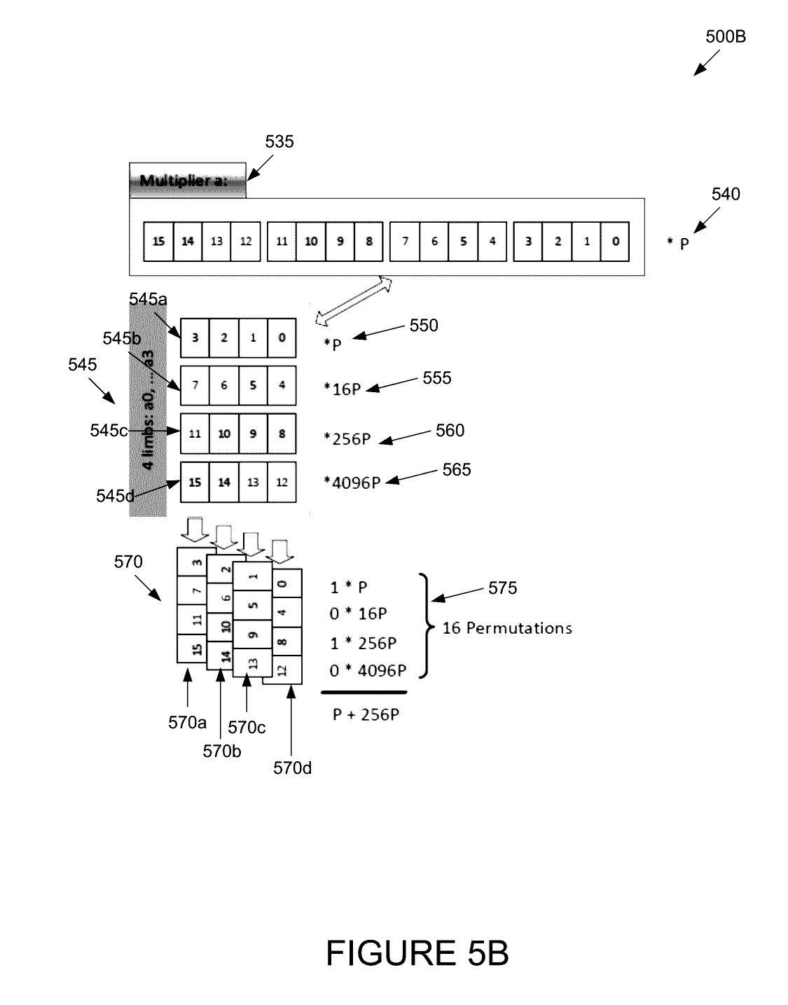

In a specific implementation, the scalar fold operation management engine 320 decomposes a specific scalar into folding units that are used as the basis of the point multiplication techniques described herein. The folding units may, as discussed herein, comprise a portion of the specific scalar that is represented by a product of a coefficient and a specified power of a specified integer. The specified integer may be chosen to maximize computational efficiency. The specified integer may be the number “2” so that a binary representation (e.g., specific chunks of bits) of the specific scalar is obtained. In various implementations, the specified power for the folding unit may be chosen based on a variety of factors, including the extent the decomposition methods utilized by the scalar fold operation management engine 320 are designed to perform computations up-front. For a specific scalar of 256 bits, the specified power may be chosen to be one of 4, 16, 64, etc., depending on the extent of front-end calculations desired. The scalar fold operation management engine 320 may also stores and/or cache in a table permutations of coefficients for each folding unit. As discussed herein, the storage/caching table sizes may vary depending on the size of the specified power. FIG. 5A shows an example of an implementation of the scalar fold operation management engine 320 in greater detail.

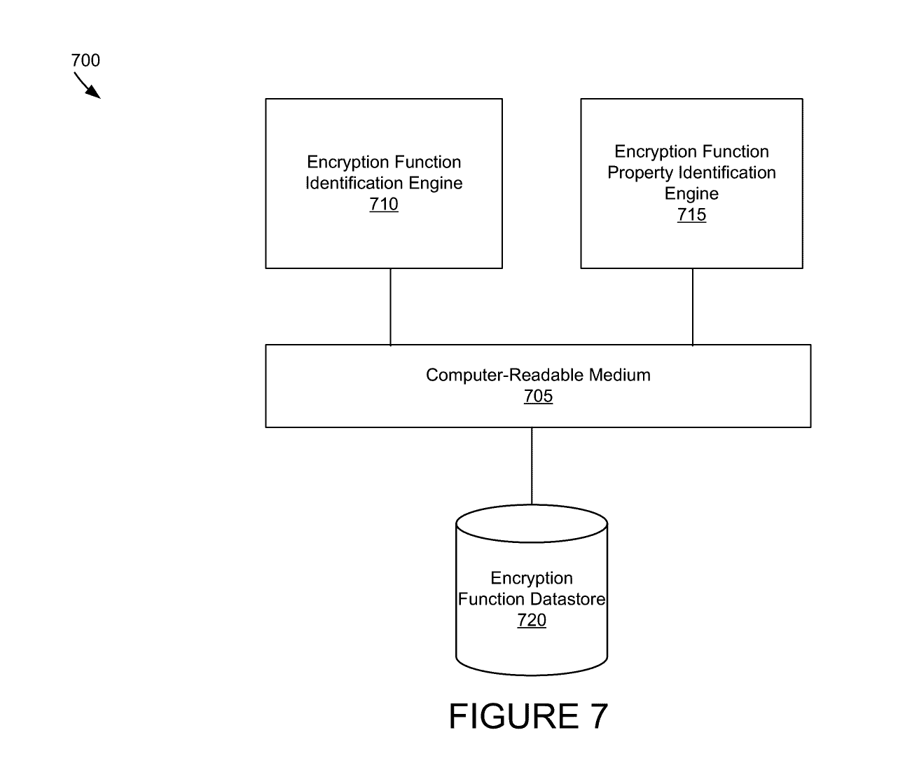

In a specific implementation, the encryption function management engine 325 may obtain encryption functions used to provide a cryptography key pair. In various implementations, the encryption function management engine 325 identifies specific encryption functions (e.g., specific elliptical curves), specific properties of encryption functions (e.g., basepoints), and other information related to encryption functions. FIG. 7 shows an example of an implementation of the encryption function management engine 325 in greater detail.

In a specific implementation, the folding unit multiplication engine 330 may multiply each folding unit against a specific basepoint of an encryption function. In various implementations, the folding unit multiplication engine 330 performs a double-and-add operation on each folding unit against the specific basepoint. The folding unit multiplication engine 330 may also perform point multiplication on each folding unit using other techniques, including windowed methods, sliding-window methods, Non-Adjacent Form methods (e.g., wNAF methods), Montgomery ladders, etc., or some combination thereof. The folding unit multiplication engine 330 may provide the point multiplication performed on each folding unit to other engines of the cryptography key computation system 300, such as the point multiplication recomposition engine 335.

In a specific implementation, the point multiplication recomposition engine 335 may add point multiplication performed on each folding unit to one another. In various implementations, the point multiplication recomposition engine 335 receives from the folding unit multiplication engine 330 the point multiplication performed on each folding unit. The point multiplication recomposition engine 335 may use point addition to perform these operations. The point multiplication recomposition engine 335 may provide the resulting point multiplication to the other engines of the cryptography key computation system 300, such as the cryptography key management engine 340. The point multiplication recomposition engine 335 may use stored/cached permutations of the coefficients for each folding unit to recompose the point multiple of the scalar and the basepoint. More specifically, the point multiplication recomposition engine 335 may perform a summation in which the products of the folding units and the scalar are added on a folding unit-by-folding unit basis. The point multiplication recomposition engine 335 may obtain specific stored/cached values from the scalar fold operation management engine, using the techniques further described herein.

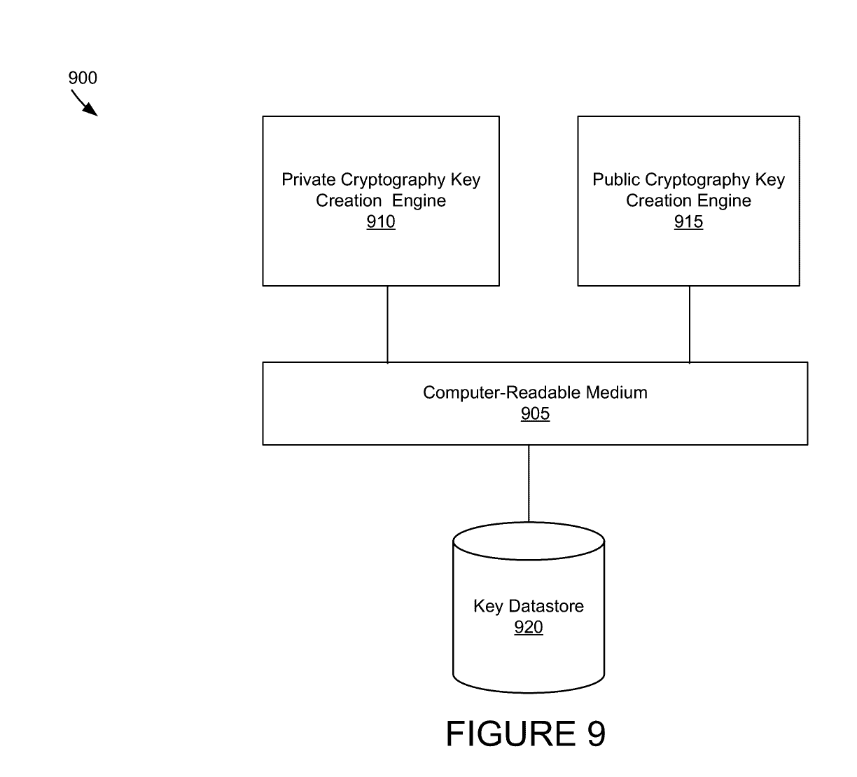

In a specific implementation, the cryptography key management engine 340 functions to provide cryptography key pairs based on the values generated by the other engines of the cryptography key computation system 300. More specifically, the cryptography key management engine 340 may create a private cryptography key based on the scalar used for the computations discussed herein. In some implementations, the value of the private cryptography key corresponds to the value of the scalar. The cryptography key management engine 340 may further create a public cryptography key based on the point multiple of the scalar and the basepoint, as discussed herein. The value of the public cryptography key may correspond to the value of the point multiple. FIG. 9 shows an example of an implementation of the cryptography key management engine 340 in greater detail.

In a specific implementation, the scalar datastore 345 stores scalars for cryptography key pairs. More specifically, the scalar datastore 345 may include a set of scalars that can be accessed by the scalar identification engine 315. The scalar datastore 345 may be populated by a random number generator, by a pseudorandom number generator, by manual input from a user interface (e.g., from a user interface on one of the user device(s) 115), or by other techniques, systems, or methods.

In a specific implementation, the encryption function datastore 350 stores data related to encryption functions. In some implementations, the encryption function datastore 350 stores data related to elliptical curve. The elliptical curves may have points, including basepoints, therein. The elliptical curves may have various limitations, including definition over a finite field, as common in many cryptography applications.

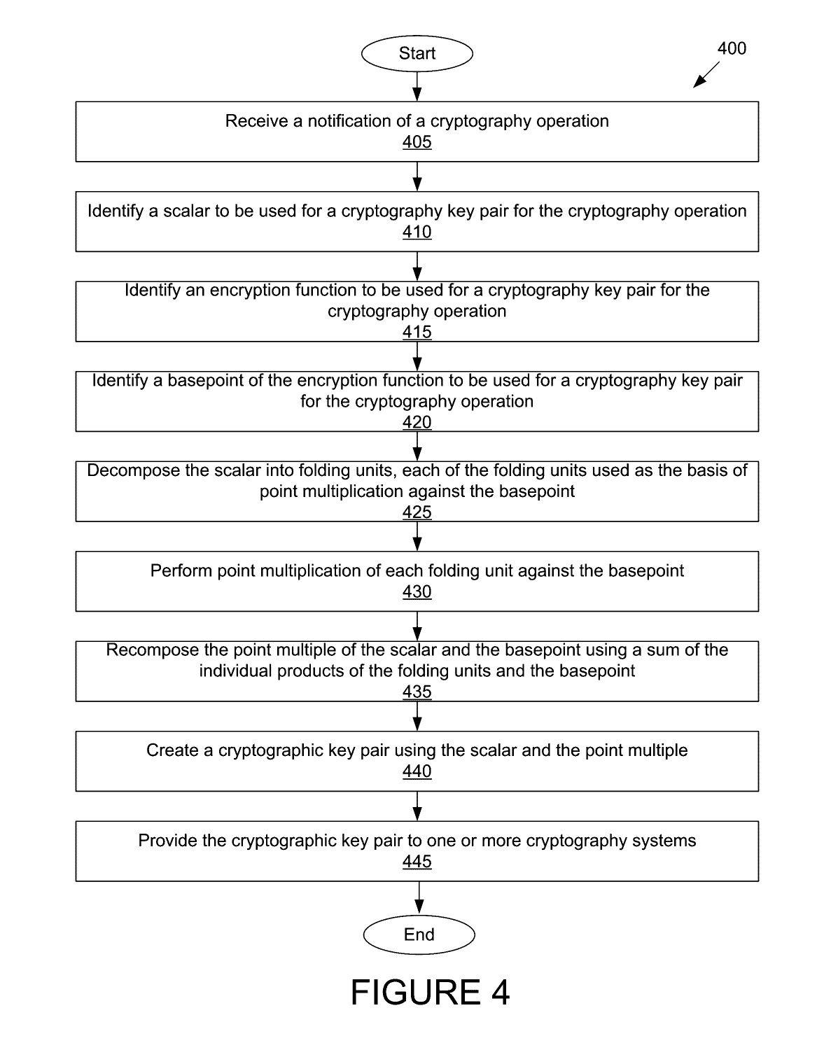

FIG. 4 is a flowchart of an example of method for creating keys by decomposing a scalar into folding units used in a cryptographic system. The flowchart 400 is discussed in conjunction with the cryptography key computation system 300, shown in FIG. 3 and discussed further herein.

At module 405, the cryptography system interface engine 310 receives a notification of a cryptography operation. The notification may arrive over the computer-readable medium 105. At module 410, the scalar identification engine 315 identifies a scalar to be used for a cryptography key pair for the cryptography operation. At module 415, the encryption function management engine 325 identifies an encryption function to be used for a cryptography key pair for the cryptography operation. At module 420, the encryption function management engine 325 identifies a basepoint of the encryption function to be used for a cryptography key pair for the cryptography operation.

At module 425, the scalar fold operation management engine 320 decomposes the scalar into folding units, each of the folding units used as the basis of point multiplication against the basepoint. As discussed, the folding units may, as discussed herein, comprise a portion of the specific scalar that is represented by a product of a coefficient and a specified power of a specified integer. The specified integer may be chosen to maximize computational efficiency.

At module 430, the folding unit multiplication engine 330 performs point multiplication of each folding unit against the basepoint. The folding unit multiplication engine 330 may use windowed methods, sliding-window methods, Non-Adjacent Form methods (e.g., wNAF methods), Montgomery ladders, etc., or some combination thereof. These methods techniques may yield individual products of the folding units and the basepoint.

At module 435, the point multiplication recomposition engine 335 recomposes the point multiple of the scalar and the basepoint using a sum of the individual products of the folding units and the basepoint. To do so, the point multiplication recomposition engine 335 may perform d or other techniques to recompose the point multiple of the scalar and the basepoint using a sum of the folding units.

At module 440, the cryptography key management engine 340 creates a cryptographic key pair using the scalar and the point multiple. More specifically, the cryptography key management engine 340 may create a private key based on the scalar, and may create a public key based on the point multiple of the scalar and the basepoint of the encryption function.

At module 445, the cryptography system interface engine 310 provides the cryptographic key pair to one or more cryptography systems 110. More specifically, the cryptography system interface engine 310 may provide, over the computer-readable medium 105, one or more of the cryptographic key pair (e.g., the public cryptography key) to one or more of the cryptography system(s) 110. In various implementations, the private key need not be distributed over the computer-readable medium 105.

FIG. 5A is a diagram showing an example of a scalar fold operation management engine 500A. The scalar fold operation management engine 500A includes a computer-readable medium 505, a scalar property identification engine 510, a scalar decomposition engine 515, a folding unit coefficient permutation management engine 520, a folding unit coefficient storage/caching engine 525, and a folding unit datastore 530. One or more of the scalar property identification engine 510, the scalar decomposition engine 515, the folding unit coefficient permutation management engine 520, and the folding unit coefficient storage/caching engine 525 may include an “engine,” as described herein. The folding unit datastore 530 may include a “datastore,” as described herein.

In the example of FIG. 5A, the computer-readable medium 505 is coupled to the scalar property identification engine 510, the scalar decomposition engine 515, the folding unit coefficient permutation management engine 520, the folding unit coefficient storage/caching engine 525, and the folding unit datastore 530. In a specific implementation, the computer-readable medium 505 may include a “computer-readable medium,” as described herein.

In a specific implementation, the scalar property identification engine 510 identify a property of a scalar that forms the basis of a private cryptography key. It is noted that while magnitude is described herein, the scalar property identification engine 510 may identify other properties of the scalar (e.g., bit length) without departing from the scope and substance of the inventive concepts described herein.

In a specific implementation, the scalar decomposition engine 515 may decompose a specific scalar into folding units. As discussed herein, the folding units may be represented by a product of a coefficient and a specified power of a specified integer. The specified power and the specified integer may depend on a variety of factors. The specified power, for instance, may depend on the extent the system is designed to perform computations up-front and/or store/cache larger values. The specified integer may depend on the computational efficiency desired.

In a specific implementation, the folding unit coefficient permutation management engine 520 may identify all permutations of coefficients of folding units for a specific scalar. The folding unit coefficient permutation management engine 520 may further provide these permutations to the other engines of the scalar fold operation management engine 500A, such as the folding unit coefficient storage/caching engine 525.

In a specific implementation, the folding unit coefficient storage/caching engine 525 may store in the folding unit datastore 530 permutations of coefficients of folding units. More specifically, the folding unit coefficient storage/caching engine 525 may obtain from the folding unit coefficient permutation management engine 520 the permutations of coefficients of folding units for a decomposed scalar.

In a specific implementation, the folding unit datastore 530 may store information relevant to the folding units. For instance, the folding unit datastore 530 may store coefficients related to folding units and/or specific permutations of coefficients of folding units. In various implementations, the folding unit datastore 530 maintains a table that stores all permutations of coefficients of folding units for decomposed scalars. It is noted the folding unit datastore 530 may maintain more than one table, or may store the coefficients related to folding units and/or specific permutations of coefficients of folding units in manners other than tabular form.

As an example of the operation of the scalar fold operation management engine 500A, consider the example of FIG. 5B. FIG. 5B is a diagram 500B showing an example of a scalar being decomposed into folding units that are cached. In the example of FIG. 5B, the scalar property identification engine 510 has identified a magnitude of a scalar 535. A basepoint 540 of an encryption function has also been provided.

More specifically, the scalar property identification engine 510 has identified a binary number 1100011100101101, which may correspond to the binary representation of the decimal 50989. (It is noted that when creating a cryptography key pair, the scalar is usually much larger, e.g., a 256-bit number, but here, a 16-bit number is shown for simplicity.)

The scalar decomposition engine 515 has decomposed this number into four folding units 545. Four folding units may have been chosen because the scalar 535 is a 16-bit number. Each of the folding units 545 has a bit length of 4. That is, the scalar decomposition engine 515 has decomposed the scalar 535 into folding units 545, each folding units 545 represented by a product of a coefficient and a power of the specified integer 2. The first folding unit 545a may be multiplied by a first part 550 of the basepoint 540. The second folding unit 545b may be multiplied by a second part 555 of the basepoint 540. The third folding unit 545c may be multiplied by a third part 560 of the basepoint 540. The fourth folding unit 545d may be multiplied by a fourth part 565 of the basepoint 540.

The folding unit coefficient permutation management engine 520 may identify all permutations of the coefficients of the folding units 545. The folding unit coefficient permutation management engine 520 may create table entries 570, including a first table entry 570a, a second table entry 570b, a third table entry 570c, and a fourth table entry 570d. The folding unit coefficient storage/caching engine 525 may store these entries in the folding unit datastore 530. As discussed herein, these table entries may form the basis of point multiplication of the scalar 535 and the basepoint 540.

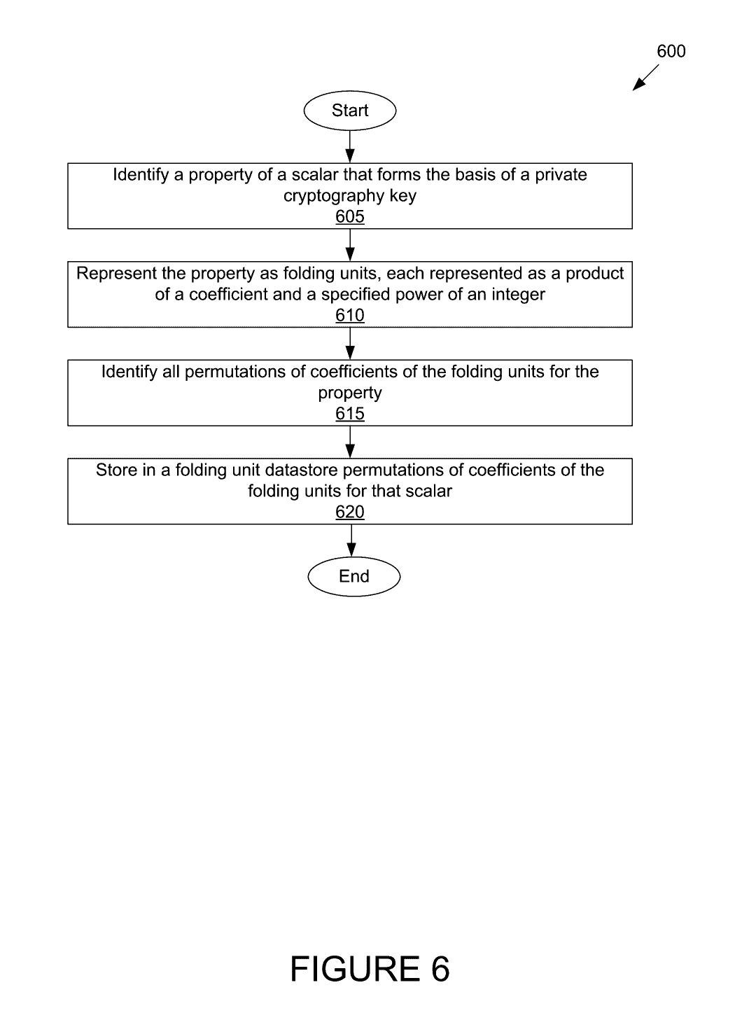

FIG. 6 is a flowchart 600 of an example of method for decomposing a scalar into folding units used in a cryptographic system. The flowchart 600 is discussed in conjunction with the a scalar fold operation management engine 500A, shown in FIG. 5A and discussed further herein.

At module 605, the scalar property identification engine 510 identifies a property of a scalar that forms the basis of a private cryptography key. The property may be the magnitude of the scalar. It is noted that while magnitude is described herein, the scalar property identification engine 510 may identify other properties of the scalar (e.g., bit length) without departing from the scope and substance of the inventive concepts described herein.

At module 610, the scalar decomposition engine 515 represents the property as folding units, each folding unit represented as a product of a coefficient and a specified power of an integer. The folding units may be represented by a product of a coefficient and a specified power of a specified integer (e.g., 2). The specified power and the specified integer may depend on a variety of factors, as discussed herein.

At module 615, the folding unit coefficient permutation management engine 520 identifies all permutations of coefficients of the folding units for the property. At module 620, the folding unit coefficient storage/caching engine 525 stores in the folding unit datastore 530 permutations of coefficients of folding units.

FIG. 7 is a diagram showing an example of an encryption function management engine 700. The encryption function management engine 700 includes a computer-readable medium 705, an encryption function identification engine 710, an encryption function property identification engine 715, and an encryption function datastore 720. One or more of the encryption function identification engine 710 and the encryption function property identification engine 715 may include an “engine,” as described herein. The encryption function datastore 720 may include a “datastore,” as described herein.

In the example of FIG. 7, the computer-readable medium 705 is coupled to the encryption function identification engine 710, the encryption function property identification engine 715, and the encryption function datastore 720. In a specific implementation, the computer-readable medium 705 may include a “computer-readable medium,” as described herein.

In a specific implementation, the encryption function identification engine 710 may identify a specific encryption function for a cryptography key pair. The encryption function may take a variety of formats. In some implementations, the encryption function comprises an elliptical curve function. The encryption function may be defined across a variety of domains. In various implementations, the encryption function may be defined over a finite field, such as a finite integer field, or other finite field.

In a specific implementation, the encryption function property identification engine 715. The encryption function property identification engine 715 may identify a basepoint of the encryption function. The encryption function property identification engine 715 may also identify other properties of the encryption function, such as slopes, tangents, curvatures, etc.

In a specific implementation, the encryption function datastore 720 stores information related to encryption functions. The encryption function datastore 720 may store basepoints, slopes, tangents, curvatures, etc. In various implementations, the encryption function datastore 720 maintains a repository of the various encryption functions that can be used to generate cryptography key pairs.

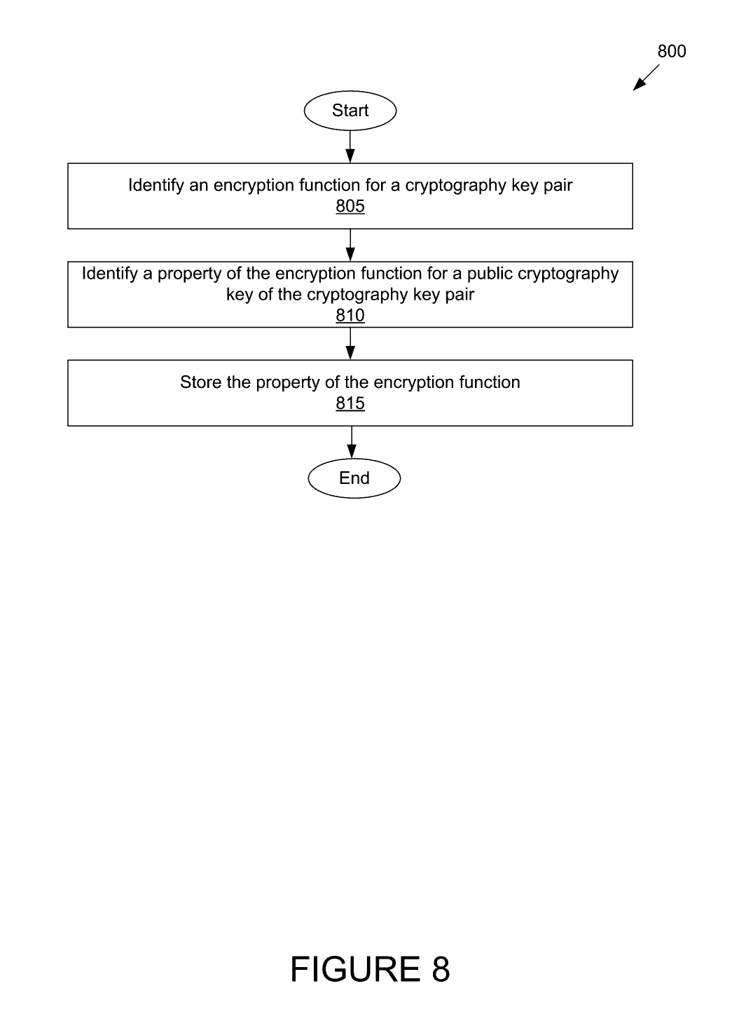

FIG. 8 is a flowchart 800 of an example of method for selecting an encryption function for a cryptography system. The flowchart 800 is discussed in conjunction with the encryption function management engine 700, shown in FIG. 7 and discussed further herein.

At module 805, the encryption function identification engine 710 identifies an encryption function for a cryptography key pair. The encryption function may comprise any convenient encryption function. In various implementations, the encryption function comprises an elliptical curve function.

At module 810, the encryption function property identification engine 715 identifies a property of the encryption function for a public cryptography key of the cryptography key pair. More specifically, the encryption function property identification engine 715 may identify a basepoint of the encryption function for a public cryptography key of the cryptography key pair. At module 815, the encryption function property identification engine 715 stores the property (e.g., the basepoint) of the encryption function in the encryption function datastore

FIG. 9 is a diagram showing an example of a cryptography key management engine 900. The cryptography key management engine 900 includes a computer-readable medium 905, a private cryptography key creation engine 910, a public cryptography key creation engine 915, and a cryptography key datastore 920. One or more of the private cryptography key creation engine 910 and the public cryptography key creation engine 915 may include an “engine,” as described herein. The cryptography key datastore 920 may include a “datastore” as described herein.

In the example of FIG. 9, the computer-readable medium 905 is coupled to the private cryptography key creation engine 910, the public cryptography key creation engine 915, and the cryptography key datastore 920. In a specific implementation, the computer-readable medium 905 may include a “computer-readable medium,” as described herein.

In a specific implementation, the private cryptography key creation engine 910 creates private cryptography keys. The private cryptography keys may be created in any convenient way. In various implementations, the private cryptography keys are based on a scalar, using the techniques described herein.

In a specific implementation, the public cryptography key creation engine 915 creates public cryptography keys. The public cryptography keys may be created in any convenient way. In various implementations, the public cryptography keys are based on a point multiple of a scalar that was used to compute a private key and a basepoint of the encryption function, using the techniques described herein.

In a specific implementation, the cryptography key datastore 920 stores cryptography key pairs generated by the private cryptography key creation engine 910 and/or the public cryptography key creation engine 915. The cryptography key datastore 920 may implement secure storage techniques to ensure cryptography keys, particularly private cryptography keys, are not distributed outside a secure environment. In various implementations, the cryptography key datastore 920 allows the cryptography system(s) 110 to access public cryptography keys.

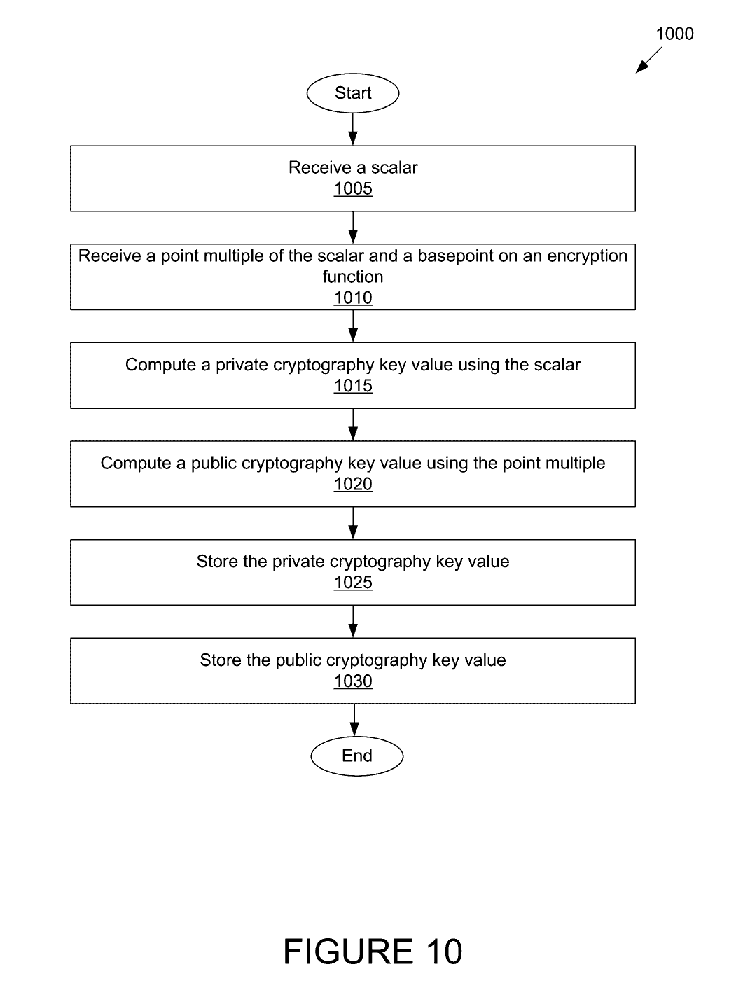

FIG. 10 is a flowchart 1000 of an example of method for creating a pair of keys used in a cryptographic system. The flowchart 1000 is discussed in conjunction with the cryptography key management engine 900, shown in FIG. 9 and discussed further herein.

At module 1005, the private cryptography key creation engine 910 receives a scalar. The scalar may be any convenient value. At module 1010, the public cryptography key creation engine 915 receives a point multiple of the scalar and a basepoint on an encryption function. As discussed herein, the encryption may be an elliptical curve over a finite field. The basepoint may be an arbitrary point on the elliptical curve used to generate the point multiple. The point multiplication may have been performed by another engine (e.g., the engines of the cryptography key computation system 300 in FIG. 3) using the techniques described in this paper.

At module 1015, the private cryptography key creation engine 910 computes a private cryptography key value using the scalar. At module 1020, the public cryptography key creation engine 915 computes a public cryptography key value using the point multiple.

At module 1025, the private cryptography key creation engine 910 stores the private cryptography key value in the cryptography key datastore 920. At module 1030, the public cryptography key creation engine 915 stores the public cryptography key value in the cryptography key datastore 920. It is noted the private cryptography key may be kept secure from discovery while the public cryptography key may be distributed to other systems (e.g., the cryptography system(s) 110 and/or other user device(s) 115).

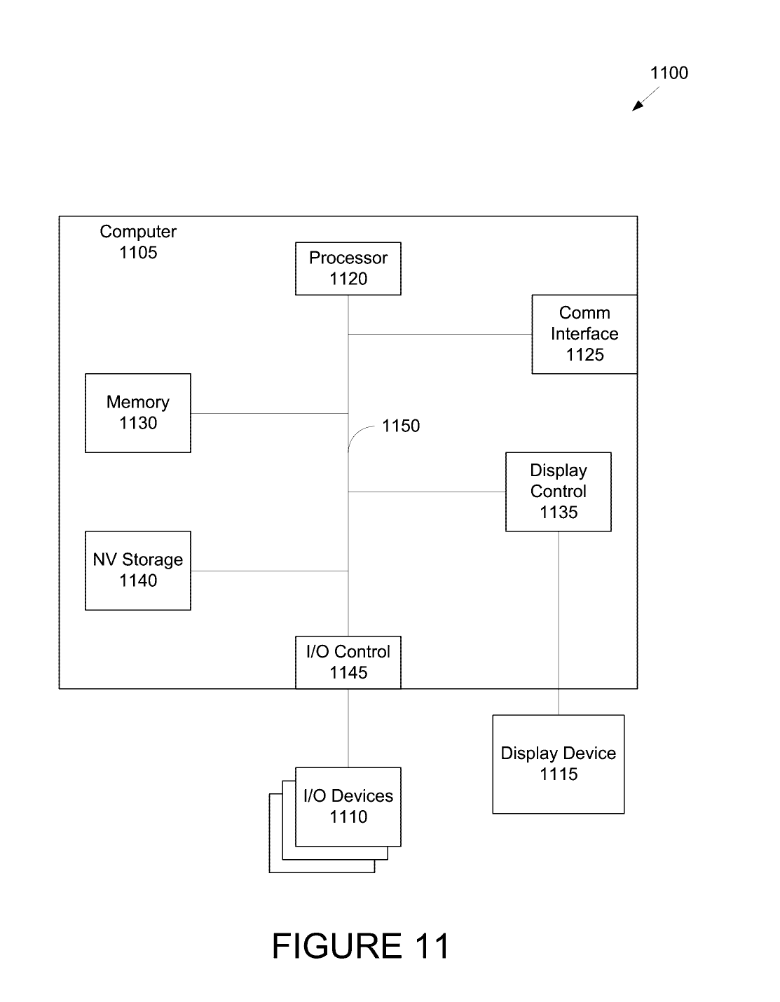

FIG. 11 shows an example of a digital device 1100. In the example of FIG. 11, the digital device 1100 can be a conventional computer system that can be used as a client computer system, such as a wireless client or a workstation, or a server computer system. The digital device 1100 includes a computer 1105, I/O devices 1110, and a display device 1115. The computer 1105 includes a processor 1120, a communications interface 1125, memory 1130, display controller 1135, non-volatile storage 1140, and I/O controller 1145. The computer 1105 can be coupled to or include the I/O devices 1110 and display device 1115.

The computer 1105 interfaces to external systems through the communications interface 1125, which can include a modem or network interface. It will be appreciated that the communications interface 1125 can be considered to be part of the digital device 1100 or a part of the computer 1105. The communications interface 1125 can be an analog modem, ISDN modem, cable modem, token ring interface, satellite transmission interface (e.g. “direct PC”), or other interfaces for coupling a computer system to other computer systems.

The processor 1120 can be, for example, a conventional microprocessor such as an Intel Pentium microprocessor or Motorola power PC microprocessor. The memory 1130 is coupled to the processor 1120 by a bus 1150. The memory 1130 can be Dynamic Random Access Memory (DRAM) and can also include Static RAM (SRAM). The bus 1150 couples the processor 1120 to the memory 1130, also to the non-volatile storage 1140, to the display controller 1135, and to the I/O controller 1145.

The I/O devices 1110 can include a keyboard, disk drives, printers, a scanner, and other input and output devices, including a mouse or other pointing device. The display controller 1135 can control in the conventional manner a display on the display device 1115, which can be, for example, a cathode ray tube (CRT) or liquid crystal display (LCD). The display controller 1135 and the I/O controller 1145 can be implemented with conventional well known technology.

The non-volatile storage 1140 is often a magnetic hard disk, an optical disk, or another form of storage for large amounts of data. Some of this data is often written, by a direct memory access process, into memory 1130 during execution of software in the computer 1105. One of skill in the art will immediately recognize that the terms “machine-readable medium” or “computer-readable medium” includes any type of storage device that is accessible by the processor 1120 and also encompasses a carrier wave that encodes a data signal.

The digital device 1100 is one example of many possible computer systems which have different architectures. For example, personal computers based on an Intel microprocessor often have multiple buses, one of which can be an I/O bus for the peripherals and one that directly connects the processor 1120 and the memory 1130 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 1130 for execution by the processor 1120. A Web TV system, which is known in the art, is also considered to be a computer system, but it can lack some of the features shown in FIG. 11, such as certain input or output devices. A typical computer system will usually include at least a processor, memory, and a bus coupling the memory to the processor.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described in this paper relate to apparatus for performing the operations. The apparatus can be specially constructed for the required purposes, or it can comprise a general purpose computer selectively activated or reconfigured by a computer program stored in the computer. Such a computer program can be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “some implementations”, “various implementations”, “certain embodiments”, “other embodiments”, “one series of embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some implementations, but also variously omitted in other embodiments. Similarly, various features are described that may be preferences or requirements for some implementations, but not other embodiments.

The language used herein has been principally selected for readability and instructional purposes, and it may not have been selected to delineate or circumscribe the inventive subject matter. It is therefore intended that the scope be limited not by this detailed description, but rather by any claims that issue on an application based hereon. Accordingly, the disclosure of the embodiments is intended to be illustrative, but not limiting, of the scope, which is set forth in the claims recited herein.

1. A system comprising:
a cryptography system interface engine configured to receive from one or more cryptography systems a notification of a cryptography operation;
a scalar identification engine coupled to the cryptography system interface engine, the scalar identification engine configured to identify a scalar to be used for a cryptography key pair for the cryptography operation;
an encryption function management engine coupled to the cryptography system interface engine, the encryption function management engine configured to identify a basepoint of an encryption function to be used for the cryptography key pair;
a scalar fold operation management engine coupled to the scalar identification engine, the scalar fold operation management engine configured to decompose the scalar into folding units, each of the folding units used for point multiplication against the basepoint;
a folding unit multiplication engine coupled to the scalar fold operation management engine, the folding unit multiplication engine configured to perform point multiplication of each of the folding units against the basepoint;
a point multiplication recomposition engine coupled to the folding unit multiplication engine, the point multiplication recomposition engine configured to recompose a point multiple of the scalar and the basepoint using a sum of individual products of the folding units and the basepoint;
a cryptography key management engine coupled to the point multiplication recomposition engine, the cryptography key management engine configured to create the cryptography key pair using the scalar and the point multiple of the scalar and the basepoint.

2. The system of claim 1, wherein the cryptography system interface engine is configured to provide one or more of the cryptography key pair to the one or more cryptography systems.

3. The system of claim 1, wherein each of the folding units comprises a product of a coefficient and specified power of an integer.

4. The system of claim 3, wherein the integer is the number 2.

5. The system of claim 1, wherein the scalar fold operation management engine is configured to:
represent a magnitude of the scalar as a product of a coefficient and a specified power of an integer;
identify one or more permutations of the coefficients;
store in a folding unit datastore the one or more permutations of the coefficients.

6. The system of claim 1, wherein the encryption function is an elliptical curve function.

7. The system of claim 1, wherein the encryption function is an elliptical curve function defined over a finite field.

8. The system of claim 1, wherein the cryptography key pair comprises a private cryptography key based on the scalar, and a public cryptography key based on the point multiple of the scalar and the basepoint.

9. The system of claim 1, wherein the scalar is generated using one or more of a random number generator and a pseudorandom number generator.

10. The system of claim 1, wherein at least a portion of the cryptography operation is performed by one or more of an encryption/decryption system, a digital signature system, and an Encrypting File System (“EFS”).

11. The system of claim 1, wherein at least a portion of the cryptography operation is performed by one or more of a server, a desktop computer, a laptop computer, a tablet computing device, a mobile phone, and an Internet of Things (“IoT”) device.

12. A method comprising:
receiving from one or more cryptography systems a notification of a cryptography operation;
identifying a scalar to be used for a cryptography key pair for the cryptography operation;
identifying a basepoint of an encryption function to be used for the cryptography key pair;
decomposing the scalar into folding units, each of the folding units used for point multiplication against the basepoint;
performing point multiplication of each of the folding units against the basepoint;
recomposing a point multiple of the scalar and the basepoint using a sum of individual products of the folding units and the basepoint;
creating the cryptography key pair using the scalar and the point multiple of the scalar and the basepoint;
providing one or more of the cryptography key pair to the one or more cryptography systems.

13. The method of claim 12, wherein each of the folding units comprises a product of a coefficient and specified power of an integer.

14. The method of claim 13, wherein the integer is the number 2.

15. The method of claim 12, wherein decomposing the scalar into the folding units comprises:
representing a magnitude of the scalar as a product of a coefficient and a specified power of an integer;
identifying one or more permutations of the coefficients;
storing in a folding unit datastore the one or more permutations of the coefficients.

16. The method of claim 12, wherein the encryption function is an elliptical curve function.

17. The method of claim 12, wherein the encryption function is an elliptical curve function defined over a finite field.

18. The method of claim 12, wherein the cryptography key pair comprises a private cryptography key based on the scalar, and a public cryptography key based on the point multiple of the scalar and the basepoint.

19. The method of claim 12, wherein the scalar is generated using one or more of a random number generator and a pseudorandom number generator.

20. The method of claim 12, wherein at least a portion of the cryptography operation is performed by one or more of an encryption/decryption system, a digital signature system, and an Encrypting File System (“EFS”).

21. The method of claim 12, wherein at least a portion of the cryptography operation is performed by one or more of a server, a desktop computer, a laptop computer, a tablet computing device, a mobile phone, and an Internet of Things (“IoT”) device.

22. A system comprising:
means for receiving from one or more cryptography systems a notification of a cryptography operation;
means for identifying a scalar to be used for a cryptography key pair for the cryptography operation;
means for identifying a basepoint of an encryption function to be used for the cryptography key pair;
means for decomposing the scalar into folding units, each of the folding units used for point multiplication against the basepoint;
means for performing point multiplication of each of the folding units against the basepoint;
means for recomposing a point multiple of the scalar and the basepoint using a sum of individual products of the folding units and the basepoint;
means for creating the cryptography key pair using the scalar and the point multiple of the scalar and the basepoint;
means for providing one or more of the cryptography key pair to the one or more cryptography systems.
